(19) United States
(12) Patent Application Publication
(10) Pub. No.: US 2025/0024781 A1
(43) Pub. Date: Jan. 23, 2025

(54) Harvesting Machines For Use In Harvesting Corn, And Related Methods

(71) Applicant: MONSANTO TECHNOLOGY LLC, Saint Louis, MO (US)

(72) Inventors: Sam Swartz DALBY, Grover, MO (US); Daniel Wesley FERGUSON, Ballwin, MO (US); Timothy Edwards REITZ, Saint Louis, MO (US); Christopher L. SCHUSTER, Boonville, MO (US)

(21) Appl. No.: 18/777,480

(22) Filed: Jul. 18, 2024

Related U.S. Application Data
(60) Provisional application No. 63/528,320, filed on Jul. 21, 2023.

(51) Int. Cl. A01D 45/02; A01B 69/00; A01D 41/127; A01D 41/14

(52) U.S. Cl. CPC A01D 45/028; A01B 69/001; A01D 41/1277; A01D 41/141

(57) ABSTRACT

Harvesting machines are provided for use in harvesting corn from corn plants. An example harvesting machine includes a tractor and at least two row units coupled to the tractor and operable to remove ears of corn from corn plants. A first row unit of the at least two row units is moveable relative to the tractor to change a height and/or rotational position of the first row unit, and a second row unit of the at least two row units is moveable relative to the tractor independent of the first row unit to change a height and/or rotational position of the first row unit.

### CROSS-REFERENCE TO RELATED APPLICATION

This application claims the benefit of, and priority to, U.S. Provisional Application No. 63/528,320, filed on Jul. 21, 2023. The entire disclosure of the above-referenced application is incorporated herein by reference.

### FIELD

The present disclosure generally relates to agricultural harvesting machines for use in harvesting corn (e.g., seed corn, etc.) and to related methods of using such harvesting machines to harvest corn (e.g., to produce seed corn, bulk up populations of seed corn, etc.).

### BACKGROUND

This section provides background information related to the present disclosure which is not necessarily prior art.

Corn plants are known to be grown in fields for commercial purposes, for example, for use as seed (to grow subsequent corn plants), or for use as feed (for animals), etc. At a point in the growing cycle, the corn plants are harvested or picked, whereby ears of corn plants are broken off from stocks of the corn plants and collected. Kernels of corn are then removed from cobs of the ears of corn and collected for subsequent use (e.g., as seed, as feed, etc.). In connection therewith, mechanized machines for harvesting the corn plants from multiple rows in the fields are known to include corn ear pickers and combine harvesters.

### SUMMARY

This section provides a general summary of the disclosure, and is not a comprehensive disclosure of its full scope or all of its features.

Example embodiments of the present disclosure generally relate to harvesting machines for use in harvesting corn from corn plants. In one embodiment, such a harvesting machine generally includes a tractor, and at least two row units coupled to the tractor and operable to remove ears of corn from corn plants. A first row unit of the at least two row units is moveable relative to the tractor to change a height and/or rotational position of the first row unit, and a second row unit of the at least two row units is moveable relative to the tractor independent of the first row unit to change a height and/or rotational position of the first row unit.

In another embodiment, such a harvesting machine generally includes a frame; at least one assembly configured to move the harvesting machine along a ground surface; an arm coupling the at least one assembly to the frame; and at least one row unit coupled to the frame and operable to remove ears of corn from corn plants. The frame is disposed above the at least one assembly

Example embodiments of the present disclosure also generally relate to methods for harvesting corn from corn plants. In one example embodiment, such a method generally includes measuring a moisture content of corn kernels on ears of corn plants in a field; identifying the ears of the corn plants for harvesting when the moisture content of the corn kernels of the corn plants satisfies a threshold moisture content; moving a harvesting machine to the identified corn plants; and removing, by the harvesting machine, only the ears of corn from the corn plants in the field satisfying the threshold moisture content while not removing ears of corn from other corn plants in the field in connection with moving the harvesting machine to the identified corn plants.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an example embodiment of harvesting machine for use in harvesting corn and including one or more aspects of the present disclosure;

FIG. 2 is another perspective view of the harvesting machine of FIG. 1;

FIG. 3 is a front elevation view of a tractor of the harvesting machine of FIG. 1, with row units of the harvesting machine removed;

FIG. 4 is another perspective view of the harvesting machine of FIG. 1;

FIG. 5 is an enlarged, fragmentary perspective view of one of the row units of the harvesting machine of FIG. 1;

FIG. 6 is another perspective view of the harvesting machine of FIG. 1;

FIGS. 7 and 8 are enlarged, fragmentary perspective views of a hopper of the harvesting machine of FIG. 1; and

FIG. 9 is a block diagram of a computing device that may be used in the harvesting machine of FIG. 1.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

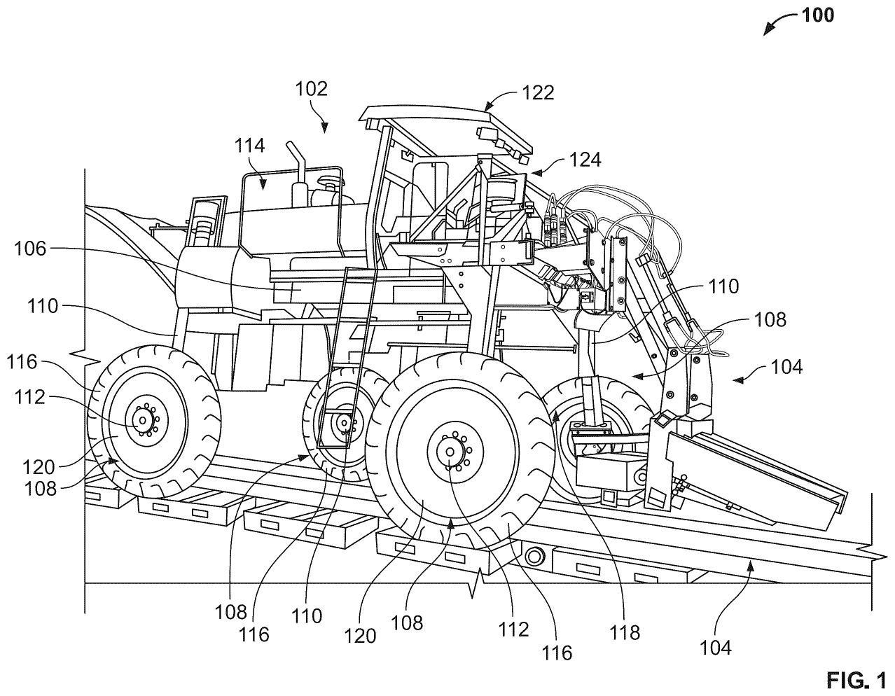

FIGS. 1-8 illustrate an example embodiment of a harvesting machine 100 (e.g., an agricultural harvester, etc.) including one or more aspects of the present disclosure. As will be described, the harvesting machine 100 is configured (e.g., is constructed and operable, etc.) to harvest whole cars of corn from corn plants in a field, as the harvesting machine 100 moves through the field. In particular, the harvesting machine 100 is configured to harvest cars of corn from corn plants in desired rows in the field (e.g., one desired row, two desired rows, three desired rows, etc.). The harvesting machine 100 is configured to then collect the cars of corn and, in some examples, deliver (or transfer) the collected cars of corn to containers, as desired (e.g., whereby kernels may then be removed from the cars of corn and collected to produce a bulk supply of seed corn that may be used to grow subsequent corn plants, etc.).

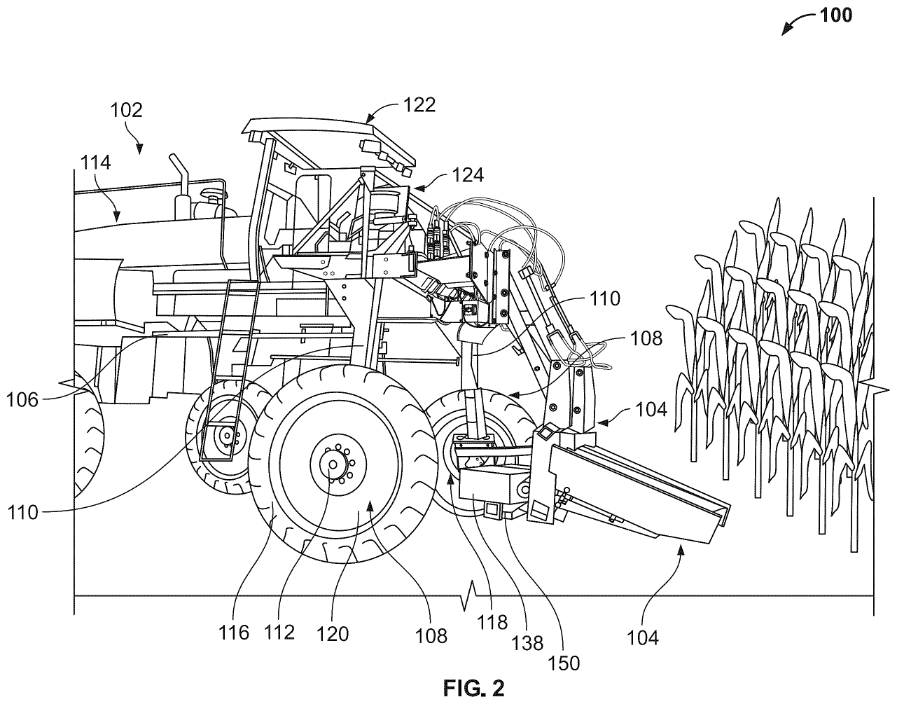

As shown in FIGS. 1 and 2, the illustrated harvesting machine 100 generally includes a tractor 102 configured to move through the field, and row units, each indicated at reference number 104, coupled to the tractor 102 and configured to receive (or collect) the cars of corn from the corn plants in the field. In the illustrated embodiment, the harvesting machine 100 is shown as including two row units 104. In other example embodiments, though, the harvesting machine 100 may include one row unit, three row units, more than three row units, etc. within the scope of the present disclosure. In general, the harvesting machine 100 may be viewed as including at least one row unit 104 coupled to (e.g., mounted to, etc.) the tractor 102 for harvesting corn in a desired row (or rows) in a field.

The tractor 102 of the harvesting machine 100 generally includes a frame 106 (or chassis) supporting the tractor 102 (e.g., supporting the various parts and/or components of the tractor 102, etc.), and multiple wheel assemblies, each indicated at reference number 108, coupled to the frame 106. The wheel assemblies 108 position the frame 106 generally above a ground surface and facilitate movement of the tractor 102, as desired, across the ground surface (e.g., where the ground surface may include dirt, crop material, grass, rock, asphalt, concrete, etc.). That said, the frame 106 may be constructed from suitable material capable of supporting the various parts and/or components of the tractor 102, including, for example, one or more metals, alloys, etc.

The wheel assemblies 108 of the tractor 102 are coupled to the frame 106 of the tractor 102 by support arms 110, each indicated at reference number 110, that extend generally downward from the frame 106. Axles, each indicated at reference number 112, are disposed toward end portions of the support arms 110 for coupling the wheel assemblies 108 thereto, with one wheel assembly 108 coupled to each support arm 110 at the corresponding axle 112 of the support arm 110. In the illustrated embodiment, the tractor 102 includes four wheel assemblies 108, including two laterally spaced apart wheel assemblies 108 positioned toward a forward part of the tractor 102 (e.g., toward the row units 104, etc.) and two laterally spaced apart wheel assemblies 108 positioned toward a rearward part of the tractor 102 (e.g., toward engine 114 of the tractor, etc.). In other example embodiments, though, the tractor 102 may include more than four wheel assemblies (e.g., six wheel assemblies, etc.) or fewer than four wheel assemblies (e.g., two wheel assemblies, etc.) within the scope of the present disclosure.

With continued reference to FIGS. 1 and 2, the wheel assemblies 108 each generally include a tire 116, and a wheel motor 118 coupled to the tire 116 (e.g., within a hub 120 of the tire 116 in the illustrated embodiment, etc.). The wheel motor 118 is configured to selectively rotate the tire 116 to thereby cause movement of the tractor 102. The tires 116 are independently operable/moveable, by way of the respective wheel motors 118, to thereby allow for added control of the tractor 102 (whereby specific power and operation can be provided to each of the wheel assemblies 108, as desired, to help drive, move, direct the tractor 102, etc. (broadly, to help steer the tractor 102)). In one example embodiment, the wheel motors 118 of the wheel assemblies 108 include hydraulic motors 118. In addition, the tires 116 of the wheel assemblies 108 may include any suitable tires (e.g., rubber wheeled tires, etc.) within the scope of the present disclosure. Further, while the illustrated embodiment shows the wheel assemblies 108 of the tractor 102 including tires 116 for moving the tractor 102 through the field, it should be appreciated that the tractor 102 (e.g., the wheel assemblies 108 of the tractor 102, etc.) may include means other than tires (or other than wheel assemblies) for facilitating such movement. For example, in some embodiments, the tractor 102 may include track assemblies having one or more tracks configured for use in moving the tractor 102 through the field, etc. (where the track assemblies may then also be considered wheel assemblies of the tractor 102).

In some example embodiments, the tractor 102 may include a steering assembly coupled to one or more of the wheel assemblies 108 for use in controlling the one or more wheel assemblies 108 and allowing for directing (or steering) a movement of the tractor 102 via movement of the one or more wheel assemblies 108 (broadly, for controlling directional movement of the tractor 102).

The tractor 102 also includes a cab 122 disposed generally above the frame 106, and the engine 114 mounted on the frame 106 generally rearward of the cab 122 (whereby both the cab 122 and the engine 114 are generally above the wheel assemblies 108). The engine 114 is configured to provide power to the tractor 102 (e.g., to the wheel motors 118, etc.) to thereby move the tractor 102 as described herein. In addition, the engine 114 is configured to provide power to the row units 104 to allow for operation of the row units 104 as described herein. In connection therewith, controls 124 are provided in the cab 122 for controlling such operation of the tractor 102 and row units 104.

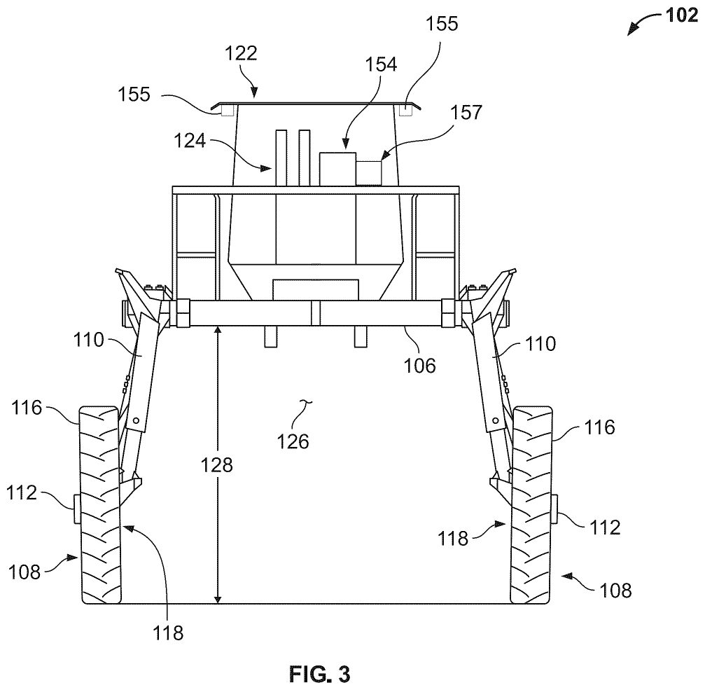

With reference to FIG. 3, the frame 106 of the tractor 102 is positioned generally above the wheel assemblies 108. And, the axles 112 of the tractor 102 are each associated with one of the wheel assemblies 108 (e.g., the axles 112 do not extend laterally under the frame 106 between the wheel assemblies 108, etc.). In this way, the illustrated tractor 102 is generally free of operating components under (or below) the frame 106 and between the wheel assemblies 108, whereby the tractor 102 generally includes an open clearance area (or zone) 126 generally under the frame 106 and between the wheel assemblies 108. As such, the tractor 102 is able to move through the field on the tires 116 of the wheel assemblies 108 (e.g., as driven by the engine 114 and the wheel motors 118, etc.) while allowing corn plants to pass under (or below) the frame 106 and between the laterally spaced apart wheel assemblies 108 (e.g., through the clearance area 126, etc.) without impacting and/or without damaging the corn plants.

In addition to the above, in the illustrated embodiment the tires 116 of the wheel assemblies 108 may have dimensions suitable to elevate the frame 106 of the tractor 102 above the ground surface a desired height (together with the support arms 110) so that the tractor 102 can move through the field. For instance, in some example embodiments, each of the tires 116 of the tractor 102 may have a diameter of about thirty inches or more, about forty inches or more, about fifty inches or more, about sixty inches or more, about one-hundred inches or less, etc. Further, the frame 106 and support arms 110 of the tractor 102 may be arranged (e.g., relative to the wheel assemblies 108, etc.) and/or sized to provide a height 128 (or clearance) of the frame 106 above the ground surface (e.g., when the tractor 102 is positioned on the ground surface on the tires 116, etc.) so as to allow the tractor 102 to pass generally over the corn plants in the field while the tractor 102 moves through the field (e.g., over fully grown corn plants, etc.). In connection therewith, in some example embodiments, the frame 106 may be positioned above the ground surface a distance of about fifty inches or more, about sixty inches or more, about seventy inches or more, about eighty inches or more, about one-hundred inches or less, etc. In view of the above, the harvesting machine 100 may therefore be viewed as, or may be understood to embody, a generally high-clearance harvesting machine, etc. (e.g., a harvesting machine capable of, or configured to, drive through a field of corn plants (e.g., fully grown corn plants, etc.) while allowing the corn plants to pass under the harvesting machine, etc.).

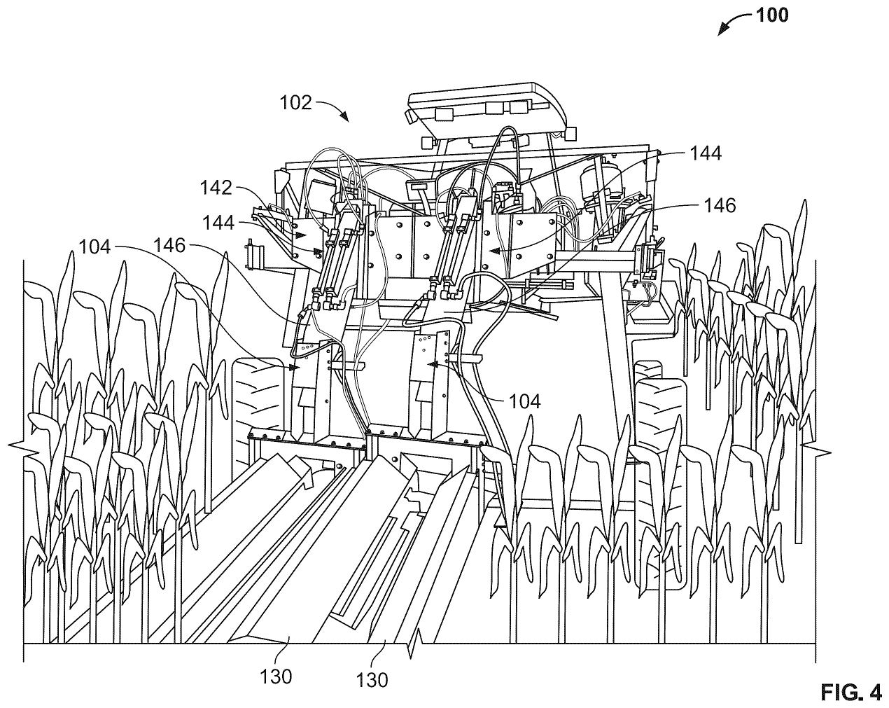

The row units 104 of the illustrated machine 100 will be described next. The row units 104 are each similar in structure and operation. As such, one of the row units 104 is described next with reference to FIGS. 4-6, with it understood that a description of the other one of the row units 104 is substantially the same.

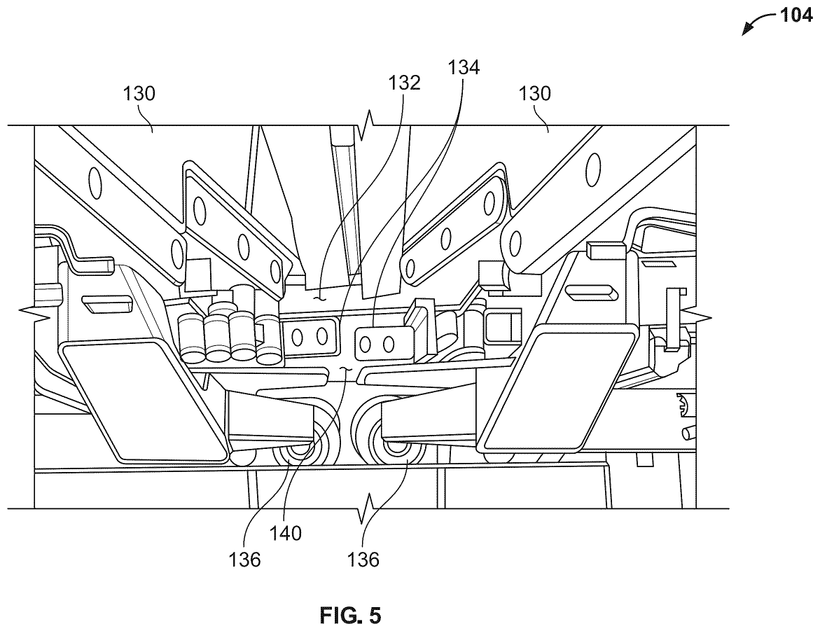

As shown in FIGS. 4 and 5, the row unit 104 is configured to channel (or direct) corn plants located in a given row (within the field) between adjacent guides, each indicated at reference number 130, of the row unit 104 and into a separation chamber 132 (generally defined between the guides 130). In connection therewith, the guides 130 are positioned generally forward of the separation chamber 132 and define a channel therebetween configured to generally guide the corn plants into row unit 104 (and separation chamber 132) as the tractor 102 moves the row unit 104 through the field.

The row unit 104 includes multiple paddles, each indicated at reference number 134, and multiple stalk rollers, each indicated at reference number 136 (e.g., rounded cylinders with blades, etc.), located generally within the separation chamber 132 for facilitating movement of the corn plants through the separation chamber 132 and removal of cars of corn from the corn plants. In particular, first and second sets of paddles 134 are located on opposite sides of the separation chamber 132, and each are driven generally in a loop for moving, aligning, etc. the corn stalks entering the separation chamber 132 toward and with the rollers 136 (e.g., in conjunction with the adjacent guides 130 of the row unit 104, etc.). The sets of paddles 134 located on the opposite sides of the separation chamber 132 are also generally staggered in position, for example, so that the paddles 134 may alternate in directing corn plants to the stalk rollers 136. The stalk rollers 136, then, operate to engage and snap the corn stalks therebetween, as they are received from the paddles 134, and remove/separate the cars of corn from the corn plants. The corn stalks then fall to the ground under the harvesting machine 100. And, the removed cars of corn are captured generally above the stalk rollers 136 and are directed into a hopper 138 (FIG. 2) disposed generally rearward of the row unit 104 (via a rearward opening 140 of the separation chamber 132 of the row unit 104, etc.). With that said, in the illustrated embodiment, the stalk rollers 136 of the row unit 104 are configured to rotate at speeds of between about 1,000 rotations per minute (rpm) and about 1,200 rpm, to thereby facilitate removal of the cars of corn from the stalks.

With continued reference to FIG. 4, the row units 104 of the machine 100 are adjustable (e.g., moveable, etc.) relative to the frame 106 of the tractor 102. For example, horizontal positions of the row units 104 on the frame 106 of the tractor 102 may be adjusted (e.g., the row units 104 may each be moved laterally relative to the frame 106 of the tractor 102, etc.) to thereby change a spacing between the row units 104 and/or to change a horizontal position of the row units 104 on the tractor 102 (e.g., to help facilitate alignment of the row units 104 with a particular row (or rows) of corn in the field, etc.). In the illustrated embodiment, the row units 104 are positioned on a tool bar 142 coupled to the frame 106 of the tractor 102. In connection therewith, the row units 104 may be manually moved (e.g., slid, etc.) along the tool bar 142 to desired positions. And, one or more mechanical fastener (e.g., a locking pin, etc.) may then be engaged between the row unit 104 and the tool bar 142 to secure the row unit 104 in the desired position along the tool bar 142. Alternatively, the row units 104 may be automatically moved (e.g., slid, etc.) along the tool bar 142 to desired positions (e.g., via an actuator such as a piston, etc.). And, one or more mechanical fastener (e.g., a locking pin, etc.) may then be automatically engaged between the row unit 104 and the tool bar 142 to secure the row unit 104 in the desired position along the tool bar 142.

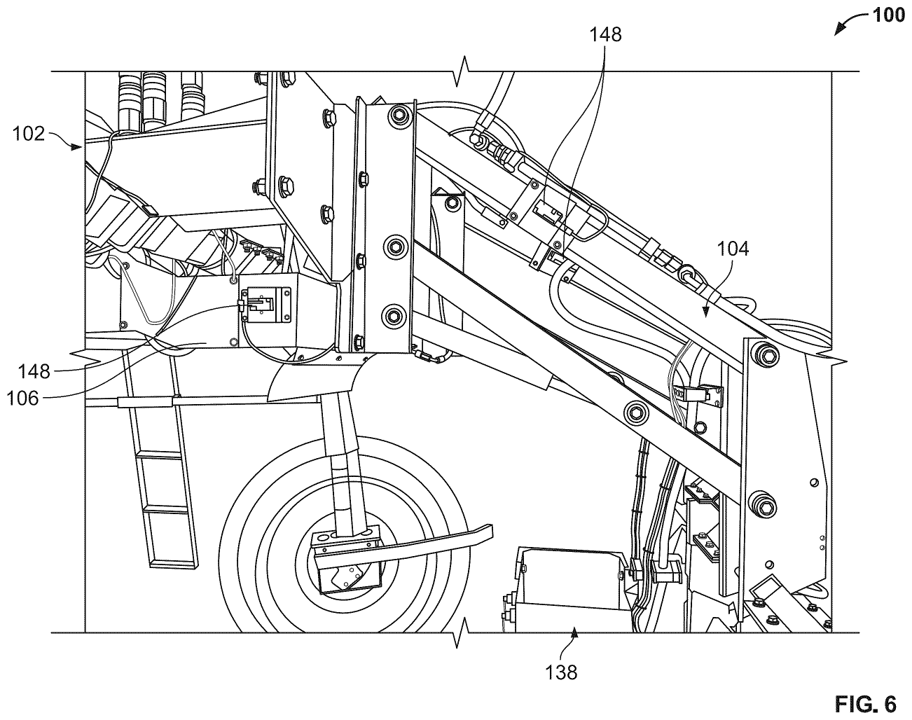

In addition, a vertical position of each of the row units 104 may be adjusted (e.g., the row units 104 may each be moved or pivoted vertically relative to the frame 106 of the tractor 102, etc.) to thereby elevate the row units 104 and/or change a vertical position of the row units 104 relative to the ground (and/or frame 106 of the tractor 102). In the illustrated embodiment, actuators, each indicated at reference number 144 (e.g., hydraulic pistons, etc.) are provided along arms, each indicated at reference number 146, of the row units 104 to thereby raise or lower the row units 104 (e.g., slide the row units 104 generally longitudinally along the arms 146, etc.) and/or to pivot the row units 104 relative to the frame 106 of the tractor 102. In this way, a vertical height and/or position of the row units 104 may be controlled (e.g., automatically, etc.) to position the row units 104 at desired heights and, in operation, to align the row units 104 with cars of corn on corn plants for collection. In connection therewith, as shown in FIG. 6, height sensors (e.g., at least one height sensor, etc.), each indicated at reference number 148, are provided for use in determining, detecting, etc. a height of the row units 104 relative to the ground (and to thereby provide reference for aligning the row units 104 with the cars of corn on the corn plants during operation). For instance, in the illustrated embodiment, height sensors 148 are provided on the row units 104 and on the frame 106 such that a variance in in readings between the height sensors 148 on the row units and the height sensor 148 on the frame may be used to provide a height of the row units 104 relative to the ground.

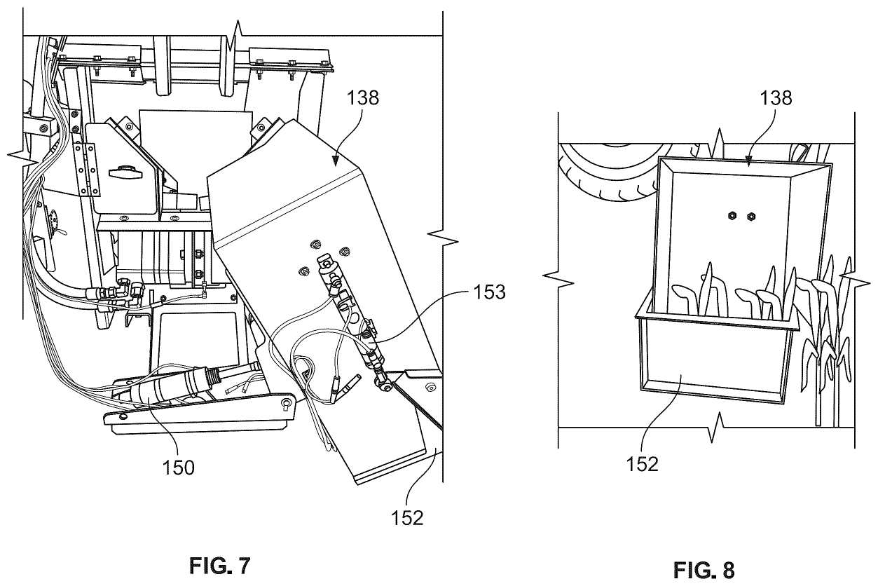

The hoppers 138 of the harvesting machine 100 are positioned generally rearward of the row units 104, with one hopper 138 associated with each of the row units 104 (and in general alignment with the opening 140 of the separation chambers 132 of the corresponding row units 104). The hoppers 138 are each moveable relative to the frame 106 of the tractor 102, for example, between a collecting position (e.g., as shown in FIGS. 2 and 6, etc.) (broadly, a first position) and a dumping or transferring position (e.g., as shown in FIGS. 7 and 8, etc.) (broadly, a second position), to allow for transferring collected cars of corn from the hoppers 138 to one or more desired containers, locations, etc. In particular, in the illustrated embodiment, each of the hoppers 138 is coupled to a corresponding actuator 150 (e.g., a piston, etc.) configured to pivot the hopper 138 relative to the row unit 104 (e.g., between the collecting position and the transferring position, etc.). In connection therewith, in the illustrated embodiment, each of the hoppers 138 include a door 152 configured to open as the hopper moves to the transferring position, for example, via a door actuator 153 that opens the door 152. In this way, the actuator 150 may operate to rotate the hopper 138 (e.g., automatically, etc.) to transfer collected cars of corn from the hopper 138 to one or more desired containers, locations, etc., for example, via the opened doors 152, etc. In other example embodiments, the door 152 may be configured to open via gravity, etc., as the hopper 138 moves to the transferring position. Further, in some example embodiments, the hoppers 138 may be operated manually (e.g., via the actuator 150, independent of the actuator 150, etc.).

The machine 100 (and the various components and/or operations thereof described herein) may be controlled (and/or coordinated) by a control unit 154 (FIG. 3), for instance, located at the tractor 102. In connection therewith, the control unit 154 may be configured to receive and/or provide instructions to the machine 100 for identifying rows of corn plants to harvest (e.g., location instructions via GPS, etc.). In addition, the control unit 154 may be configured to receive signals from the sensors 148 to aid in aligning the row units 104 with cars of corn during harvesting operation. Further, the control unit 154 may be configured to receive and/or provide instructions to the machine 100 for transferring cars of corn collected in the hoppers 138 to desired containers (e.g., location instructions for the containers, sample identification instructions for the cars of corn in the hoppers 138 that are to be transferred (e.g., where the harvested cars of corn may be associated with a particular sample ID associated with a particular location of the cars of corn in the field, a particular moisture content of the cars of corn, etc.), etc.).

The illustrated harvesting machine 100 also includes cameras 155 (broadly, imaging devices, etc.) (FIG. 3) configured to capture images of the row units 104 and/or hoppers 138, for example, during operation of the harvesting machine 100. In doing so, pictures, videos, etc. (e.g., at least one image, etc.) captured by the cameras 155 may be displayed at a display device 157 of the machine 100 (e.g., located at the tractor 102, etc.) (e.g., the cameras 155 may be configured to transmit the at least one image to the display device 157 (e.g., via the control unit 154, etc.), etc.). Such images may help with operation of the machine 100 and control, etc. of the row units 104, hoppers 138, etc. While the cameras 155 are shown mounted to the tractor 102 in the illustrated embodiment, the cameras 155 may be mounted to the row units 104, hoppers, 138, etc. in other example embodiments. In addition, in some example embodiments, the images captured by the cameras 155 may be displayed on one or more computing devices away from the machine 100 (e.g., at a personal computing device of a user associated with the machine 100, etc.).

An example operation of the harvesting machine 100 to collect (or harvest) cars of corn from corn plants in desired (or selected or identified) rows in a field (e.g., as part of a seed corn production process, etc.) will be described next. In this example, the field includes multiple plots of corn plants, and each plot includes multiple rows of the corn plants. In connection therewith, in this example operation, the harvesting machine 100 is used to harvest cars of corn from corn plants in specific ones of the rows in a desired one of plots (without harvesting corn in cars of corn other rows in the plot or in other plots in the field, and without damaging corn plants in the field from which ears of corn are not harvested in operation of the harvesting machine 100 moving through the field to the corn plants to be harvested).

In this example, the rows of corn to be harvested by the harvesting machine 100 may be identified and/or selected based on moisture content of the corn kernels of the corn plants in the rows. For instance, the corn plants in the rows may be identified for harvesting when the corn kernels of the cars of corn have a moisture content of about 40% or less, about 35% or less, about 30% or less, about 25% or less (e.g., between about 15% and about 25%, etc.) (broadly, have or satisfy a threshold moisture content, etc.). In connection therewith, the moisture content of the corn kernels in the field may be measured using near-infrared spectroscopy (wherein moisture in the corn kernels absorbs certain wavelengths of light and wherein the amount of such wavelength absorption provides an indication of the amount of moisture in the corn kernel). In particular, in measuring the moisture content of the corn kernels, a portable device (e.g., as available from Perten Instruments, etc.) may be used to obtain multiple measurements from different locations in the field. Then, in this example, when the measurements indicate that the corn plants in certain rows of the field have moisture content readings of a desired threshold or less, the rows may be designated to be harvested by the harvesting machine 100.

Once the rows of corn plants to be harvested are identified, the harvesting machine 100 is moved to the field, and the row units 104 are elevated and/or pivoted upward so as to be generally above the corn plants in the field. The harvesting machine 100 is then driven through the field to the plot having the desired rows of corn plants for harvesting (e.g., based on instructions from the control unit 154, etc.). In doing so, as the harvesting machine 100 moves, the tires 116 of the tractor 102 are aligned between rows of the corn plants. And, the corn plants aligned with the tractor 102, but not identified for harvest, move generally under the elevated row units 104 and under the frame 106 without damage (through the clearance area 126), due to the elevation (or height or clearance) of the frame 106. In this way, the harvesting machine 100 is able to move to the desired location in the field for harvesting identified corn plants, without disturbing, damaging, or harvesting corn plants at other locations in the field (which are not intended to be harvested). In other words, the harvesting machine 100 is configured for use in harvesting only targeted corn plants in a field.

In turn, once the harvesting machine 100 reaches the desired rows for harvesting, the row units 104 are lowered to a desired height for harvesting cars of corn from the corn plants in the desired rows in the field (e.g., using signals provided by the sensors 148, etc.). The harvesting machine 100 is then positioned so that the corn plants in the desired rows are in alignment between the respective guides 130 of the row units 104. And, the harvesting machine 100 is operated (e.g., moved, driven, etc.) through the field at a rate (or speed) for harvesting cars of corn from the identified corn plants (e.g., as a manageable rate for operating the harvesting machine 100 in the field and/or as an identified rate to provide a desired flow of corn plants into the row units 104 for processing, etc.). In connection therewith, the stalk rollers 136 of the row units 104 are operated to separate the cars of corn from the stalks of the corn plants as the corn plants are received between the guides 130 and into the separation chamber 132. In doing so, a speed of the stalk rollers 136 may be set so as to enable the row units 104 to effectively match a rate at which corn plants are received by the row units 104 based on the operating rate (or speed) of the harvesting machine 100 (and to remove the cars of corn from the corn plants at a rate that helps inhibit the stalk rollers 136 from clogging with multiple corn plants and/or removing cars of corn too quickly whereby the cars may not be received into the separation chambers 132 and/or hoppers 138, etc.).

The cars of corn that are removed from the corn plants are directed by the row units 104 to the hoppers 138 (via the opening 140 of the separation chamber 132). The cars of corn are then collected in the hoppers 138 as the harvesting machine 100 continues to move through the field. When a desired number of cars of corn have been harvested from the particular rows of corn plants, or desired ears of corn have been harvested from the identified corn plants, the row units 104 of the harvesting machine 100 may again be elevated and/or pivoted upward so as to be generally above the corn plants in the field. The harvesting machine 100 is then driven through the field to desired locations where the collected cars of corn in the hoppers 138 are transferred to desired containers (or receptacles or bins). In connection therewith, radio-frequency identification (RFID) tags or other indicators may be included on or in the containers, for use by the harvesting machine 100 to locate and identify the desired containers to which the collected ears of corn are to be transferred (e.g., as identified or located via the control unit 154, etc.). Then, in order to transfer the collected cars of corn, the harvesting machine 100 may be positioned adjacent the containers (e.g., such that one or both of the hoppers 138 are in alignment with desired one(s) of the containers, etc.), and the actuators 150 associated with the hoppers 138 are actuated to pivot the hoppers 138 and thereby transfer the collected cars of corn from the hoppers 138 to the desired containers. In this way, the harvested cars of corn (as part of a given sampling, experiment, etc.) may be kept together for subsequent processing. And, the harvesting machine 100 may then continue to harvest cars of corn in the field from desired rows by repeating the above-described operations, as needed.

The cars of corn received in the containers from the hoppers 138 of the harvesting machine 100 may later be collected and processed to produce corn seed. For instance, the collected ears of corn may be transported to processing facilitates, still intact to help protect the kernels during transport and inhibit undesired loss of kernels, whereat the cars of corn are de-husked and dried and the kernels are then removed from the cobs.

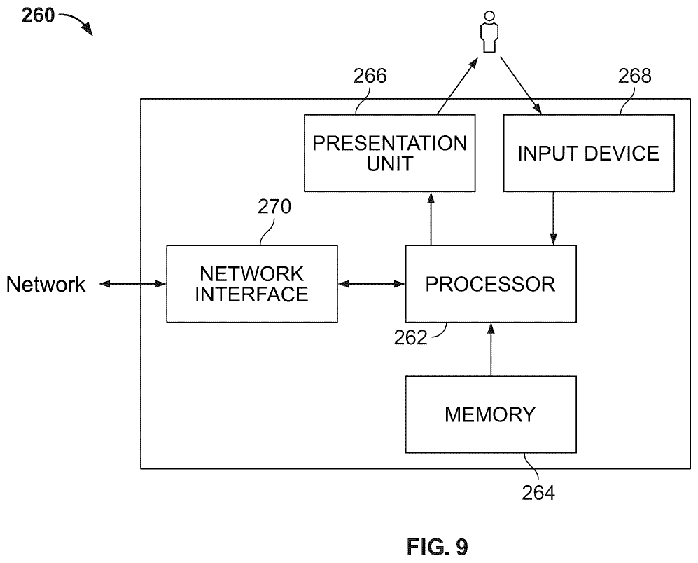

FIG. 9 illustrates an example computing device 260 that can be used in connection with the harvesting machine 100 described herein. The computing device 260 may include, for example, one or more servers, workstations, personal computers, laptops, tablets, smartphones, etc. In addition, the computing device 260 may include a single computing device, or it may include multiple computing devices located in close proximity or distributed over a geographic region, so long as the computing devices are specifically configured to function as described herein. In connection therewith, the control unit 154 of the harvesting machine 100 may include and/or may be considered a computing device consistent with the computing device 260. The present disclosure should not be considered to be limited to the computing device, as described below, as different computing devices and/or arrangements of computing devices and/or arrangement of components associated with such computing devices may be used.

The example computing device 260 includes a processor 262 and a memory 264 coupled to (and in communication with) the processor 262. The processor 262 may include one or more processing units (e.g., in a multi-core configuration, etc.). For example, the processor 262 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 264, as described herein, is one or more devices that permit data, instructions, etc., to be stored therein and retrieved therefrom. The memory 264 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 264 may be configured to store, without limitation, planting plans, planting maps, the various data (and/or corresponding data structures) described herein. Furthermore, in various embodiments, computer-executable instructions may be stored in the memory 264 for execution by the processor 262 to cause the processor 262 to perform one or more of the functions described herein (e.g., in connection with operation of the harvesting machine 100, etc.), such that the memory 264 is a physical, tangible, and non-transitory computer readable storage media. Such instructions often improve the efficiencies and/or performance of the processor 262 and/or other computer system components configured to perform one or more of the various operations herein. It should be appreciated that the memory 264 may include a variety of different memories, each implemented in one or more of the functions or processes described herein.

In the example embodiment, the computing device 260 also includes a presentation unit 266 that is coupled to (and is in communication with) the processor 262 (however, it should be appreciated that the computing device 260 could include output devices other than the presentation unit 266, etc.). The presentation unit 266 outputs information to users of the computing device 260 as desired. And, various interfaces (e.g., as defined by network-based applications, etc.) may be displayed at computing device 260, and in particular at presentation unit 266, to display such information. The presentation unit 266 may include, without limitation, a liquid crystal display (LCD), a light-emitting diode (LED) display, an organic LED (OLED) display, an “electronic ink” display, speakers, etc. In some embodiments, the presentation unit 266 may include multiple devices.

In addition, the computing device 260 includes an input device 268 that receives inputs from the users of the computing device 260. The input device 268 may include a single input device or multiple input devices. The input device 268 is coupled to (and is in communication with) the processor 262 and may include, for example, one or more of a keyboard, a pointing device, a mouse, a touch sensitive panel (e.g., a touch pad or a touch screen, etc.), another computing device 260, and/or an audio input device 268. Further, in various example embodiments, a touch screen, such as that included in a tablet, a smartphone, or similar device, may behave as both the presentation unit 266 and the input device 268.

Further, the illustrated computing device 260 also includes a network interface 270 coupled to (and in communication with) the processor 262 and the memory 264. The network interface 270 may include, without limitation, a wired network adapter, a wireless network adapter, a mobile network adapter, or other device capable of communicating to one or more different networks, GPS receivers, etc. In some example embodiments, the computing device 260 may include the processor 262 and one or more network interfaces incorporated into or with the processor 262.

The foregoing description of the embodiments has been provided for purposes of illustration and description. It is not intended to be exhaustive or to limit the present disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the present disclosure, and all such modifications are intended to be included within the scope of the present disclosure.

Example embodiments have been provided so that this disclosure will be thorough, and will fully convey the scope to those who are skilled in the art. Numerous specific details are set forth such as examples of specific components, assemblies, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, components, and/or groups thereof, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” and the phrase “at least one of” includes any and all combinations of one or more of the associated listed items.

Although the terms first, second, third, etc. may be used herein to describe various elements, components, seeds, members and/or sections, these elements, components, seeds, members and/or sections should not be limited by these terms. These terms may be only used to distinguish one element, component, seed, member or section from another element, component, seed, member or section. Terms such as “first,” “second,” and other numerical terms when used herein do not imply a sequence or order unless clearly indicated by the context. Thus, a first element, component, seed, member or section discussed below could be termed a second element, component, seed, member or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A harvesting machine for use in harvesting corn from corn plants, the harvesting machine comprising:
a tractor; and
at least two row units coupled to the tractor and operable to remove ears of corn from corn plants, a first row unit of the at least two row units moveable relative to the tractor to change a height and/or rotational position of the first row unit, and a second row unit of the at least two row units moveable relative to the tractor independent of the first row unit to change a height and/or rotational position of the first row unit.

2. The harvesting machine of claim 1, wherein the tractor includes at least one wheel assembly configured to move the harvesting machine along a ground surface.

3. The harvesting machine of claim 2, wherein the tractor includes a frame; and
wherein the harvesting machine includes at least one arm coupling the at least one wheel assembly to the frame of the tractor, the frame disposed above the at least one wheel assembly.

4. The harvesting machine of claim 2, wherein the at least one wheel assembly includes four wheel assemblies.

5. The harvesting machine of claim 2, wherein the at least one wheel assembly includes at least one tire.

6. The harvesting machine of claim 5, wherein the at least one wheel assembly includes at least one wheel motor coupled to the at least one tire.

7. The harvesting machine of claim 6, wherein the frame defines a clearance of about fifty inches or more above a ground surface on which the harvesting machine is positioned.

8. The harvesting machine of claim 1, further comprising a tool bar coupling the at least two row units to the tractor, wherein the first row unit of the at least two row units is moveable along the tool bar relative to the second row unit of the at least two row units.

9. The harvesting machine of claim 1, wherein the first row unit of the at least two row units includes multiple stalk rollers configured to separate an ear of corn from a stalk of a corn plant.

10. The harvesting machine of claim 9, wherein the first row unit of the at least two row units further includes guides configured to guide the corn plant toward the stalk rollers.

11. The harvesting machine of claim 1, further comprising a hopper disposed adjacent the first row unit of the at least two row units, the hopper configured to receive the ears of corn removed from the corn plants by the first row unit.

12. The harvesting machine of claim 11, further comprising an actuator coupled to the hopper, the actuator configured to rotate the hopper relative to the first row unit of the at least two row units to discharge the ears of corn from the hopper.

13. The harvesting machine of claim 11, further comprising at least one camera configured to capture at least one image of at least one of the at least two row units and/or of the hopper.

14. A harvesting machine for use in harvesting corn from corn plants, the harvesting machine comprising:
a frame;
at least one assembly configured to move the harvesting machine along a ground surface;
an arm coupling the at least one assembly to the frame; and
at least one row unit coupled to the frame and operable to remove ears of corn from corn plants;
wherein the frame is disposed above the at least one assembly.

15. The harvesting machine of claim 14, wherein the at least one assembly includes a wheel assembly having a tire.

16. The harvesting machine of claim 14, wherein the frame defines a clearance of about fifty inches or more above a ground surface on which the harvesting machine is positioned.

17. The harvesting machine of claim 14, further comprising at least one camera configured to capture at least one image of the at least one row unit.

18. A method for harvesting corn from corn plants, the method comprising:
measuring a moisture content of corn kernels on ears of corn plants in a field;
identifying the ears of the corn plants for harvesting when the moisture content of the corn kernels of the corn plants satisfies a threshold moisture content;
moving a harvesting machine to the identified corn plants; and
removing, by the harvesting machine, only the ears of corn from the corn plants in the field satisfying the threshold moisture content while not removing ears of corn from other corn plants in the field in connection with moving the harvesting machine to the identified corn plants.
